(19) United States
(12) Patent Application Publication
(10) Pub. No.: US 2024/0261992 A1
(43) Pub. Date: Aug. 8, 2024

(54) RAZOR CARTRIDGE WITH A PRINTED MEMBER

(71) Applicant: The Gillette Company LLC, Boston, MA (US)

(72) Inventors: Sandra Nichole Isaacs, Cincinnati, OH (US); Hui Yang, Quincy, MA (US); Keesha Alicia Riley, Melrose, MA (US); James Joseph Caissie, Hudson, MA (US)

(21) Appl. No.: 18/107,079

(22) Filed: Feb. 8, 2023

(51) Int. Cl. B26B 21/44; B26B 21/40

(52) U.S. Cl. CPC B26B 21/443; B26B 21/4018; B26B 21/4025

(57) ABSTRACT

A razor cartridge including a guard at a front portion of the cartridge, a cap at a back portion of the cartridge, at least one blade positioned between the guard and the cap, a top surface and an opposing bottom surface, and a lubricating member positioned in the cartridge at the top surface. The lubricating member has a visible surface with a visible surface area. The visible surface includes a printed structure on the visible surface of the lubricating member. The printed structure is formed from a UV curable ink and covers a portion of the visible surface area creating a printed portion and an open portion. The UV curable ink having a contact angle from 65 to 80 degrees and a work of adhesion from 45 to 60 mJ/m².

### FIELD OF THE INVENTION

The invention relates to razors, and more particularly to razor cartridges having lubricating members with printed portions.

### BACKGROUND OF THE INVENTION

The use of shaving aids on razor blades to provide lubrication benefits during the shave is known. See e.g., U.S. Pat. Nos. 7,121,754; 6,298,558; 5,711,076; 5,134,775; 6,301,785; and U.S. Patent Publ. Nos. 2009/0223057 and 2006/0225285. These shaving aids are also commonly referred to as lubrication strips or lubrication members. These types of lubrication strips have been used for years in the shaving industry. The strips are typically extruded making them very cost effective. They may also be extruded in two or more colors to provide both a visual and a functional benefit. The visual benefits being limited by the capabilities of the extruder.

It is an object of the present invention to provide a lubricating member for a razor cartridge with printing directly on the lubricating member and where the printed image(s) on the lubricating member exhibit long-lasting wear.

### SUMMARY OF THE INVENTION

One aspect of this invention relates to a razor cartridge. The razor cartridge comprises a guard at a front portion of the cartridge, a cap at a back portion of the cartridge, at least one blade positioned between the guard and the cap, a top surface, and a lubricating member positioned at the top surface. The lubricating member has a visible surface and the visible surface has a visible surface area. A printed structure is on the visible surface of the lubricating member. The printed structure comprises a UV curable ink and covers a portion of the visible surface area creating a printed portion and an open portion. The UV curable ink has a contact angle with the lubricating member from 65 to 80 degrees and a work of adhesion from 45 to 60 mJ/m² with the lubricating member.

The lubricating member within the open portion is directly exposed to a user's skin during shaving.

The printed portion is directly exposed to a user's skin during shaving.

The lubricating member may be positioned on the cap, on the guard, or be in the form of a ring partially or completely surrounding the blade.

The printed structure may comprise a plurality of printed droplets. The printed droplets adjacent to one another may be spaced apart from one another or may overlap each other.

The printed portion may cover from 3% to 70% of the visible surface area. The printed portion may cover from 5% to 40% of the visible surface area. The printed portion may cover from 10% to 30% of the visible surface area.

The printed structure may take the form of alphanumeric characters or text. The printed structure may take the form of non-alphanumeric graphics such as lines, shapes, figures, or patterns to name a few.

### BRIEF DESCRIPTION OF THE DRAWINGS

While the specification concludes with claims particularly pointing out and distinctly claiming the subject matter which is regarded as forming the present invention, it is believed that the invention will be better understood from the following description which is taken in conjunction with the accompanying drawings in which like designations are used to designate substantially identical elements, and in which:

FIG. 1 is a front view of a razor cartridge of the present invention.

FIG. 2 is a sectional view taken along line 2-2 of FIG. 1.

FIG. 3 is a side elevation view of a lubricating member of the present invention.

FIG. 4 is an enlarged view of a portion of the lubricating member shown in FIG. 1.

FIG. 5 is a side view of a printing process of the present invention.

FIG. 6 is a side view of a printing process of the present invention.

FIG. 7 depicts contact angle data for the inventive and comparative examples.

FIG. 8 depicts work of adhesion data for the inventive and comparative examples.

FIG. 9 depicts visual images from technical wear testing of the comparative and inventive examples.

FIG. 10 is a front view of another razor cartridge of the present invention.

FIG. 11 is a front view of another razor cartridge of the present invention.

### DETAILED DESCRIPTION OF THE INVENTION

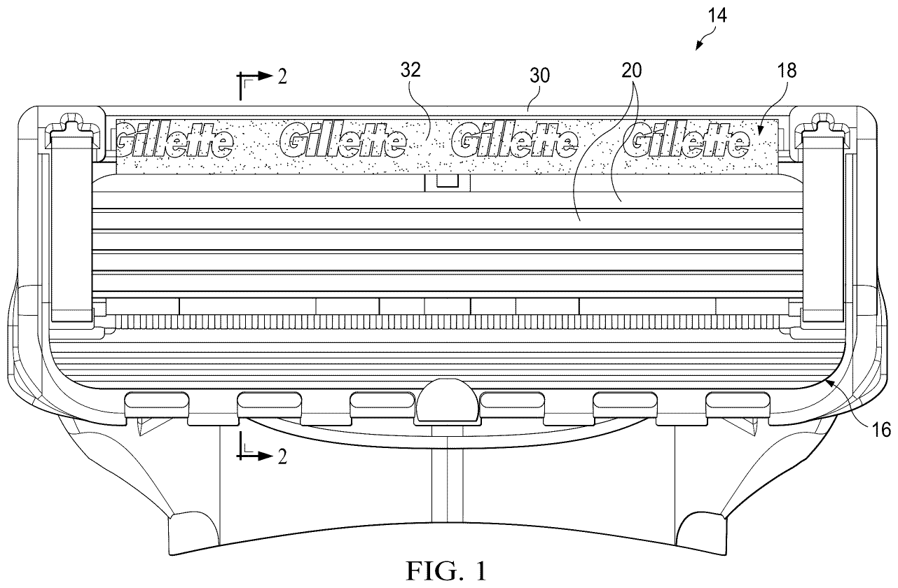

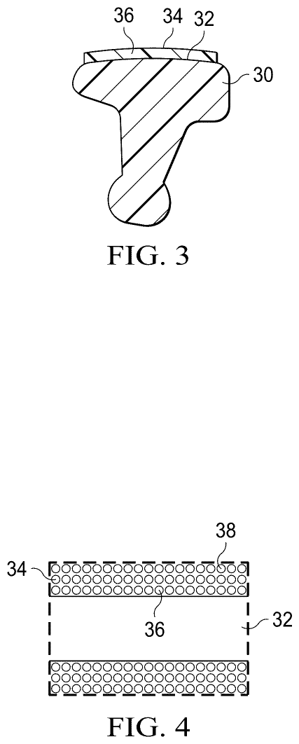

Referring to FIGS. 1-4, the razor cartridge 14 includes a guard 16 positioned at a front portion of the cartridge 14, a cap 18 positioned at a back portion of cartridge 14, and blades 20 positioned between guard 16 and cap 18. Cartridge 14 includes a top surface 22 and an opposing bottom surface 24. A lubricating member 30 is positioned on the top surface 22 of the cartridge 14. Lubricating member 30 has a visible or top surface 32. The visible surface 32 has a visible surface area that can be seen by a user.

The guard 16 may include one or more elongated flexible protrusions 17 to engage a user's skin. The flexible protrusions 17 include flexible fins generally parallel to the one or more elongated blades 20. In another embodiment, the flexible fins have at least one portion which is not generally parallel to the one or more elongated edges. Non-limiting examples of suitable guards include those used in current razor blades and include those disclosed in U.S. Pat. Nos. 7,607,230 and 7,024,776; (disclosing elastomeric/flexible fin bars) and U.S. Publ. Nos. 2008/0034590 (disclosing curved guard fins) and 2009/0049695A1 (disclosing an elastomeric guard having a guard forming at least one passage extending between an upper surface and a lower surface).

The lubricating member 30 along with guard 16, cap 18, and blades 20 form the skin engaging portion of the cartridge 14. The lubricating member 30 is preferably locked in (via adhesive, a fitment, or melt bonding) an opening or on a plate or other surface of the cartridge 14.

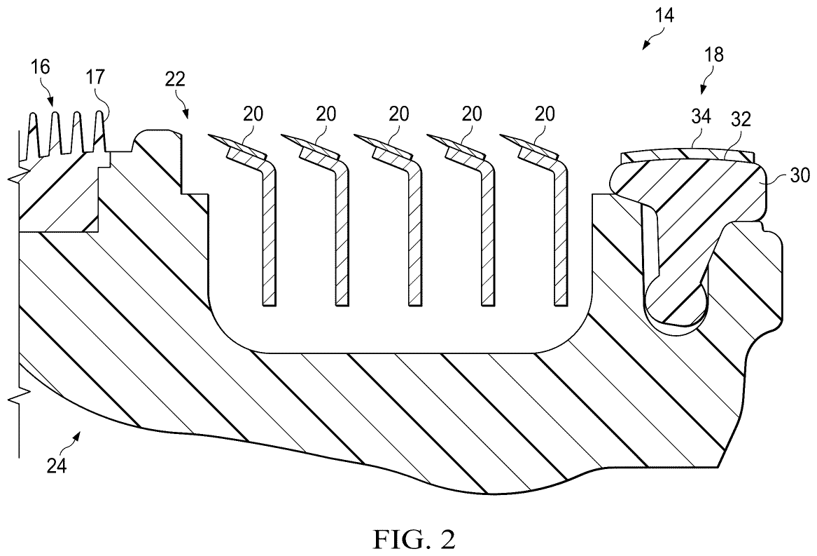

The lubricating member 30 is located on the cartridge such that the lubricating member 30 contacts or engages the skin during the hair removal process, forward and/or aft of the blades and/or along the sides of the cartridge between the forward and aft portions. A feature “forward” of the one or more elongated blade edges, for example, is positioned so that the surface to be treated by the cartridge or hair removal device encounters the feature before it encounters the elongated edges. A feature “aft” of the elongated blade edge(s) is positioned so that the surface to be treated by the cartridge or hair removal device encounters the feature after it encounters the elongated blade edges. In FIGS. 1-2 the lubricating member 30 is positioned aft of the blades 20 on the cap 18. Where more than one lubricating member is provided on the cartridge, the lubricating members can be the same or different. By different, meaning having a different size, a different shape, a different composition, a different function, and/or a different printed image thereon.

In one embodiment, the lubricating member 30 comprises a solid polymeric matrix comprising a water-soluble polymer material having a melting point of from about 150° C. to about 250° C. and optionally a water-insoluble polymer material. In one embodiment, the matrix comprises a water soluble polymer comprising at least one of a polyethylene oxide, polyvinyl pyrrolidone, polyacrylamide, polyhydroxymethacrylate, polyvinyl imidazoline, polyethylene glycol, polyvinyl alcohol, polyhydroxyethymethacrylate, silicone polymers, and mixtures thereof. In one embodiment, said water soluble polymer is selected from the group consisting of polyethylene oxide, polyethylene glycol, and a mixture thereof.

The lubricating member 30 may comprise other ingredients commonly found in commercially available lubricating members, such as those used on razor cartridges by Gillette, Schick or BIC. Non-limiting examples of such lubricating members include those disclosed in U.S. Pat. Nos. 6,301,785; 6,442,839; 6,298,558; 6,302,785, and U.S. Patent Publ. Nos. 2008/060201 and 2009/0223057. The lubricating member may also comprise an ingredient selected from the group consisting of polyethylene oxide, polyvinyl pyrrolidone, polyacrylamide, hydroxypropyl cellulose, polyvinyl imidazoline, polyethylene glycol, poly vinyl alcohol, polyhydroxyethylmethacrylate, silicone copolymers, sucrose stearate, vitamin E, soaps, surfactants, panthenol, aloe, plasticizers, such as polyethylene glycol; beard softeners; additional lubricants, such as silicone oil, Teflon® polytetrafluoroethylene powders (manufactured by DuPont), and waxes; essential oils such as menthol, camphor, eugenol, eucalyptol, safrol and methyl salicylate; tackifiers such as Hercules Regalrez 1094 and 1126; non-volatile cooling agents, inclusion complexes of skin-soothing agents with cyclodextrins; fragrances; antipruritic/counterirritant materials; antimicrobial/keratolytic materials such as Resorcinol; anti-inflammatory agents such as Candilla wax and glycyrrhetinic acid; astringents such as zinc sulfate; surfactants such as pluronic and iconol materials; compatibilizers such as styrene-b-EO copolymers; mineral oil, polycaprolactone (PCL), and combinations thereof.

The water-soluble polymer will preferably comprise at least 50%, more preferably at least 60%, by weight of the skin engaging member, up to 99%, or up to 90% of the matrix. The more preferred water soluble polymers are the polyethylene oxides generally known as POLYOX (available from Dow or ALKOX (available from Meisei Chemical Works, Kyoto, Japan). These polyethylene oxides will preferably have mol·wt·s of 100,000 to 6 million, most preferably 300,000 to 5 million. The most preferred polyethylene oxide comprises a blend of 40 to 80% of polyethylene oxide having an average mol·wt. of about 5 million (e.g. POLYOX COAGULANT) and 60 to 20% of polyethylene oxide having an average mol·wt. of about 300,000 (e.g. POLYOX WSR-N-750). The polyethylene oxide blend may also advantageously contain up to about 10% by weight of a low mol·wt. (i.e. MW<10,000) polyethylene glycol such as PEG-100.

The matrix may comprise from about 0.5% to about 50%, preferably from about 1% to about 20%, polycaprolactone (preferably mol·wt. of 30,000 to 60,000 daltons). See U.S. Pat. No. 6,302,785.

The lubricating member may contain other conventional ingredients, such as low mol·wt. water-soluble release enhancing agents such as polyethylene glycol (MW<10,000, e.g., 1-10% by weight PEG-100), water-swellable release enhancing agents such as cross-linked polyacrylics (e.g., 2-7% by weight), colorants, antioxidants, preservatives, vitamin E, aloe, cooling agents, essential oils, beard softeners, astringents, medicinal agents, etc.

The matrix can further comprise a water-insoluble polymer in which the water-soluble polymer is dispersed. Preferably, at a level of from about 0% to about 50%, more preferably about 5% to about 40%, and most preferably about 15% to about 35% by weight of the skin engaging member is a water-insoluble polymer. Suitable water-insoluble polymers which can be used include polyethylene (PE), polypropylene, polystyrene (PS), butadiene-styrene copolymer (e.g. medium and high impact polystyrene), polyacetal, acrylonitrile-butadiene-styrene copolymer, ethylene vinyl acetate copolymer, polyurethane, and blends thereof such as polypropylene/polystyrene blend or polystyrene/impact polystyrene blend.

One preferred water-insoluble polymer is polystyrene, preferably a general purpose polystyrene or a high impact polystyrene such as Styrenics 5410 from Ineos (i.e. polystyrene-butadiene), such as BASF 495F KG21. The water-insoluble polymer provides mechanical strength to the lubricating member for production and during use.

Another preferred water-insoluble polymer is Ethylene Vinyl Acetate (EVA). The EVA may comprise from about 10% to about 50% of the lubricating member, preferably about 22% to about 40%. EVA's are available in a variety of grades, which may be characterized by the % Vinyl Acetate (VA) incorporated into the polymer. The EVA of the present invention may comprise a single grade of EVA or a mixture of EVA's of different grades. Any grade or variety of EVA may be used in forming the lubricating member, such as a general purpose EVA. Preferred grades of EVA include EVA's having a vinyl acetate % of about 18 or less.

The lubricating member may be made by extrusion or another high temperature processing, such as injection molding, compacting, ultrasonic or radio frequency sintering, and slot coating.

The blended components of the lubricating member may be extruded through a Haake System 90, ¾ inch diameter extruder with a barrel pressure of about 1000-2000 psi, a rotor speed of about 10 to 50 rpm, and a temperature of about 150°-185° C. and a die temperature of about 170°-185° C. Alternatively, a 1¼ inch single screw extruder may be employed with a processing temperature of 175°-200° ° C., preferably 185°-190° ° C., a screw speed of 20 to 50 rpm, preferably 25 to 35 rpm, and an extrusion pressure of 1800 to 5000 psi, preferably 2000 to 3500 psi. The extruded strip is air cooled to about 25° C. To injection mold the strips it is preferred to first extrude the powder blend into pellets. This can be done on a 1¼ or 1½ inch single screw extruder at a temperature of 120°-180° C., preferably 140°-150° C., with a screw speed of 20 to 100 rpm, preferably 45 to 70 rpm. The pellets are then molded in either a single material molding or multi-material molding machine, which may be single cavity or multi-cavity, optionally equipped with a hot-runner system. The process temperature can be from 165° to 250° C., preferably from 180° to 225° C. The injection pressure should be sufficient to fill the part completely without flashing. Depending on the cavity size, configuration, and quantity, the injection pressure can range from 300 to 2500 psi. The cycle time is dependent on the same parameters and can range from 3 to 30 seconds, with the optimum generally being about 6 to 15 seconds. In one embodiment, one or more feeds can be preheated or they can be fed in at ambient temperature.

In one embodiment, the lubricating member is attached to the cartridge via a carrier. The lubricating member can be a molded soap formulation and can be integrally formed (meaning they are formed in the same process, such as where they are both cast together in a single mold) with the carrier, or not integrally formed (meaning the lubricating member can be attached to the carrier via a mechanical attachment, such as where the lubricating member is molded or otherwise fitted around a retaining portion of the carrier, or bonded via adhesive or heat). Non-limiting examples of suitable lubricating members include the soap wings present on Venus Breeze® line of 2-in-1 razor, and/or the moisturizing solid on the Schick® Intuition® line of razors. In one embodiment, the lubricating member and carrier can resemble the shaving aids and shaving aid holders disclosed in U.S. Patent Publ. Nos. 2006/225285A and 2006/080837A, and/or U.S. Pat. No. 7,811,553.

Referring now to FIG. 4, the printed portion 36 of the printed structure 34 on the visible surface 32 comprises a plurality of printed droplets 38. The size of the printed droplets 38 may be consistent throughout the printed structure 34. The size of the printed droplets 38 may vary throughout the printed structure. Adjacent printed droplets 38 overlap one another. Adjacent printed droplets may touch one another.

The printed droplets may be applied with suitable types of devices including, but not limited to print heads, nozzles, and other types of material deposition devices. Any suitable type of print heads can be used including, but not limited to inkjet print heads. In certain embodiments, the deposition device is an ink jet print head. The print heads may be of a non-contacting, digital type of deposition device. By “non-contacting”, it is meant that the print heads do not contact the surface to be printed. By “digital”, it is meant that the print heads can apply droplets of ink only where needed such as to form a pattern in the form of words, figures (e.g., pictures), or designs.

Ink jet print heads will typically comprise multiple nozzles. The nozzles are generally aligned in rows and are configured to jet ink in a particular direction that is generally parallel to that of the other nozzles. The nozzles within each row on a print head can be aligned linearly. Alternatively, the nozzles may be in one or more rows that are oriented diagonally relative to the longer dimension (or length) of the print head. Both such arrangements of nozzles can be considered to be substantially linearly arrayed. The inkjet print heads can comprise any suitable number and arrangement of nozzles therein. One suitable inkjet print head contains approximately 360 nozzles per inch (per 2.54 cm). The Xaar 1001 is an example of a suitable print head for use herein, and is available from Xaar of Cambridge, UK.

The droplets of ink can range in diameter from about 10 microns or less to about 200 microns, or more. The droplets of ink can be distributed in any suitable number over a given area. Typically, in ink jet printing, the ink droplets form a matrix in which the number of drops per inch (DPI) is specified in the direction of movement of the print head or article to be printed, and in a direction on the surface of the article perpendicular thereto. The application of ink droplets provided on the surface of the lubricating member to form a solid image can range from about 80, or less up to about 2,880 or more droplets per inch (DPI) in at least one direction.

The apparatus can comprise a printing apparatus with any suitable number, arrangement, and type of print heads. For example, the apparatus may comprise between 1-20, or more, print heads. The print heads may be arranged in a spaced apart relationship. Alternatively, one or more of the print heads may be positioned adjacent and in contact with another one of the print heads.

If there is more than one print head, the different print heads can print cyan, magenta, yellow, and black or any other combination of desired colors.

The ink of the present invention is preferably an ultra-violet (UV) curable ink. UV curable inks are generally monomer/oligomer based with photosensitive molecules that initiate a polymerization reaction (e.g. curing) when exposed to UV light. This reaction is near instantaneous once the ink lands on a substrate. The cross linking that occurs during curing provides a durable ink with good adhesion to the substrate.

Suitable types of UV curable ink that may be used include free radical and cationic. Both free radical and cationic UV inks are cured when exposed to UV light. When free radical inks are exposed to UV light a photoinitiator absorbs the UV light generating free radicals which react with double bonds causing chain reaction and polymerization. When cationic inks are exposed to UV light a photoinitiator absorbs the UV light generating a Lewis acid which reacts with epoxy groups resulting in polymerization.

Other types of UV curable inks may also be used. Examples of such UV curable inks include but are not limited to hybrid UV/water inks and hybrid UV/oil inks.

The high cure rates of UV curable inks translate into very high operating speeds. Thus, UV curable inks can be advantageously run on high-speed production equipment without having to allow for excessively large dryers, as would be necessary for other ink systems. The rapid cure rate also allows UV curable inks to be used to provide multiple layers in succession without having to move the substrate after each layer. This in turn allows for elevation, structuring, texturing, and colors to be easily incorporated.

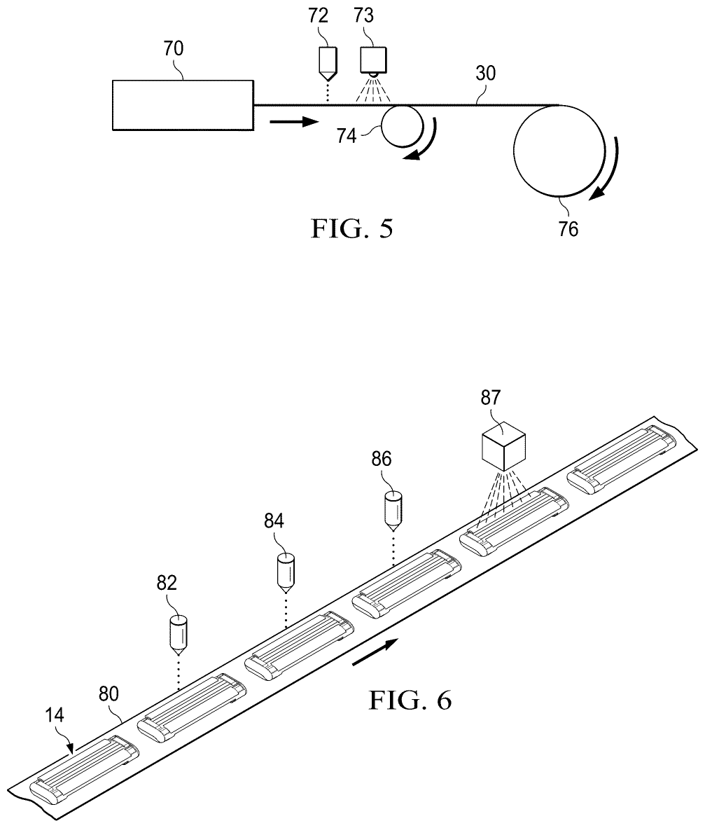

Referring to FIG. 5, there is shown an extruder 70 extruding a lubricating member 30. Printing station 72 containing multiple print heads prints ink in the form of droplets 38 on lubricating member 30, such as shown in FIG. 4. A light unit 73 directs UV light toward lubricating member 30 to cure the ink. Lubricating member is supported by roller 74 until taken up by wind up roll 76.

Referring to FIG. 6, there is shown a web 80 carrying independent cartridges 14 such as shown in FIG. 1. Cartridges 14 pass under print stations 82, 84 and 86 which print ink in the form of droplets 38 on lubricating member 30 such as shown in FIG. 4. A light unit 87 directs UV light toward cartridge 14 to cure the ink. Cartridges 14 can then pass to the next processing station by web 80.

Other forms or techniques of printing may be used. However, ink jet printing of UV curable inks is preferred given the advantages associated with ink jet printing of UV curable inks. The UV curable ink is an ideal material for the structure. Upon curing the UV curable ink forms a durable ink that does not easily erode during shaving maintaining its integrity after multiple shaves. This integrity maintenance provided by the UV curable ink allows the structure to maintain a consistent flow of lubrication from the lubricating member through the structure over multiple shaves.

High-precision ink printing generally requires using inks that have a contact angle of about 90 degrees with the material being printed. The 90 degree contact angle ensures that the ink does not “spread” over the surface of the material being printed, causing the resulting image to be blurred. Inks with a contact angle with less than 90 degrees tend to spread while inks with a contact angle greater than 90 degrees can “ball up” on the surface being printed, again resulting in a blurred image.

Surprisingly, inks useful in the present invention have a contact angle, as measured on the lubricating material, of less than 90 degrees while still providing fine text and images. The lower contact angle corresponds with an increased work of adhesion. Without being bound by theory, it is believed that the ability of the inks to spread into the roughness of the surface of the lubricating member increases the work of adhesion, and hence the longevity of the printed image during use.

It has further been found that the fineness of the image can be controlled by fast-curing the ink droplets so that they spread somewhat, but not to the point of blurring the image.

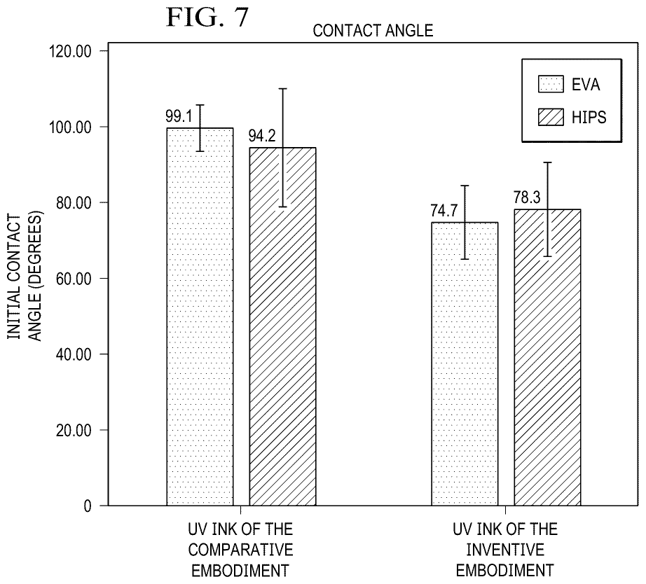

FIG. 7 depicts contact angles for two UV curable inks, one comparative example and one inventive example, as taken on the lubricating materials. Two contact angle measurements were taken for both UV inks. As can be seen the comparative example had contact angles of 99.1 and 94.2 degrees with the lubricating member. The UV ink example of the present invention had contact angles of 74.7 and 78.3 degrees with the lubricating member. UV inks of the present invention have contact angles from 65 to 80 degrees with the lubricating member.

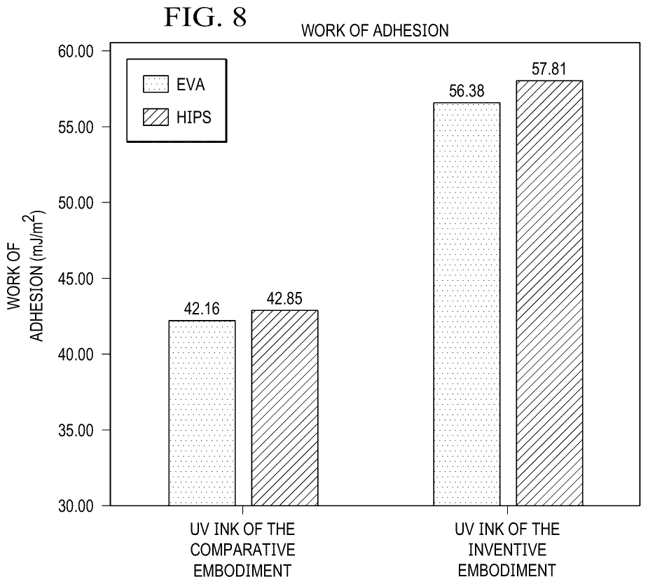

FIG. 8 depicts the work-of-adhesion for the comparative example and one inventive example. Two work of adhesion measurements were taken for both UV inks. As can be seen the comparative example had a work of adhesion of 42.16 and 42.85 mJ/m² with the lubricating member. The UV ink example of the present invention had a work of adhesion of 56.38 and 57.81 mJ/m² with the lubricating member. UV inks of the present invention have a work of adhesion from 45 to 60 mJ/m² with the lubricating member.

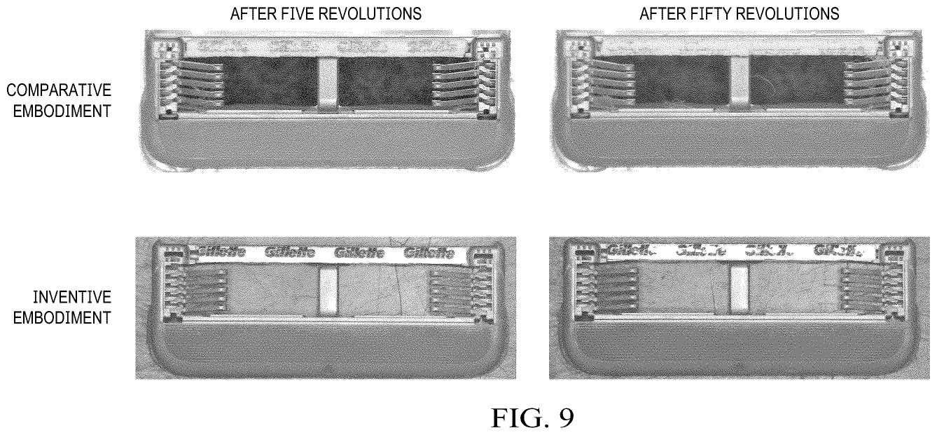

FIG. 9 shows images of razor cartridges with lubricating members having been subject to wear testing which is described below. As can be seen in the images the UV ink of the present invention has superior image quality to that of the comparative example when subject to wear tests of 5 and 50 revolutions. Surprisingly, the ink exhibiting the contact angle of less-than 90 degrees resulted in high precision image quality and superior wear. As can be seen that the printing of the inventive embodiment is more durable than the comparative example.

Both the comparative and inventive inks were assessed on lubricating members wherein the polymer matrix was high-impact polystyrene and ethylene vinyl acetate.

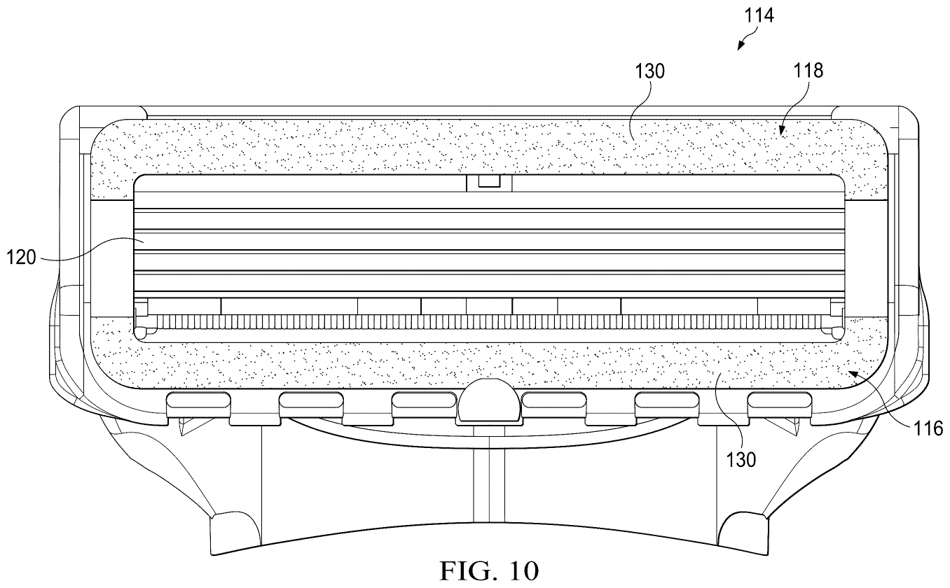

Referring to FIG. 10, the razor cartridge 114 includes a guard 116 positioned at a front portion of the cartridge 114, a cap 118 positioned at a back portion of cartridge 114, and blades 120 positioned between guard 116 and cap 118. Cartridge 114 includes a top surface and an opposing bottom surface. A lubricating member 130 is positioned on the top surface of the cartridge 114. Lubricating member 130 partially surrounds blades 120.

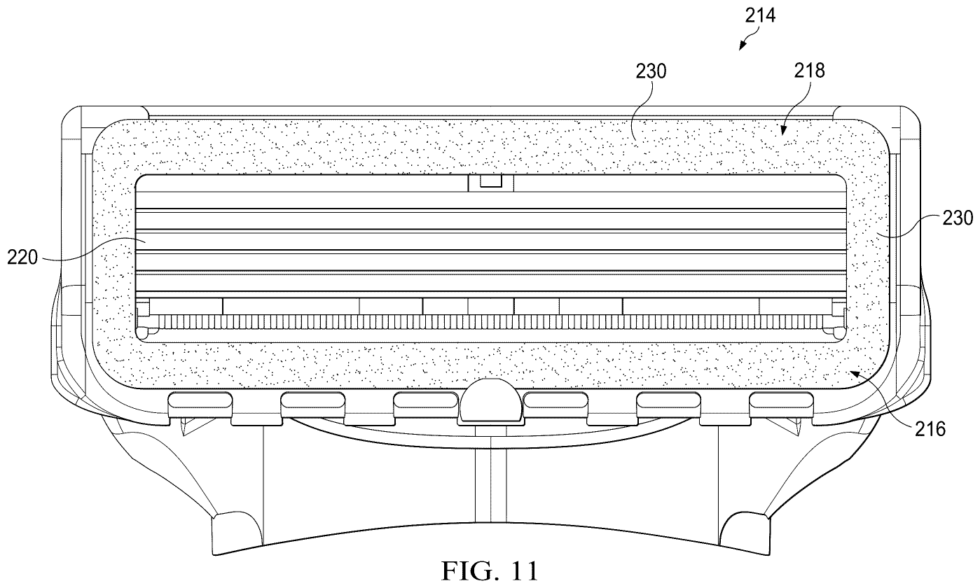

Referring to FIG. 11, the razor cartridge 214 includes a guard 216 positioned at a front portion of the cartridge 214, a cap 218 positioned at a back portion of cartridge 214, and blades 220 positioned between guard 216 and cap 218. Cartridge 214 includes a top surface and an opposing bottom surface. A lubricating member 230 is positioned on the top surface of the cartridge 214. Lubricating member 230 completely surrounds blades 220.

TABLE 1
Composition of lubricating material and technical data

| | HIPS | EVA |
|---|---|---|
| HIPS | 23.5% | n/a |
| EVA | n/a | 35% |
| PEO N750 | 19.9% | n/a |
| PEO N750-B4 | 5% | n/a |
| PEO N750-E4 | n/a | 5% |
| PEO COAG | 37.35% | 44% |
| PEG DOW 4600 | 5% | 5% |
| POLYCAPROLACTONE CAPA6506 | 5% | 5% |
| HIPS-based COLORANT | 4% | n/a |
| EVA-based COLORANT | n/a | 4% |
| Antioxidant A | 0.25% | n/a |
| Antioxidant B | n/a | 2% |
| Technical Data | | |
| Contact angle (Comparative UV Ink) | 94.2° | 99.1° |
| Work of adhesion (Comparative UV Ink) | 42.85 mJ/m² | 42.16 mJ/m² |
| Contact angle (Inventive UV Ink) | 78.3° | 74.7° |
| Work of adhesion (Inventive UV Ink) | 57.81 mJ/m² | 56.38 mJ/m² |

Adhesion of Ink Samples using Wilhelmy Plate and Contact Angle

Equilibrium total surface tension of ink samples is determined using a modified ASTM D1331-20 Method C for Standard Test Methods for Surface and Interfacial Tension of Solutions of Paints, Solvents, Solutions of Surface-Active Agents, and Related Materials; Surface Tension by Wilhelmy Plate.

Contact angles on lubricating material are determined using a modified ASTM D7490-13 Standard Test Method for Measurement of the Surface Tension of Solid Coatings, Substrates and Pigments using Contact Angle Measurements.

Contact angles on both sides of the drops of ink samples are measured on 3 cm cut sections of lubricating material. The average contact angle of the droplets is then substituted into the Young-Dupré along with the surface tension of the ink samples (see section B for determination of surface tension properties). The work of adhesion for the ink samples on the lubricating material can then be solved. Initial contact angles (the first measurable contact angle when the ink droplet hits the surface of the lubricating material) is also reported.

Equipment used for Wilhelmy Plate and Contact Angle Method

Tensiometer—A force tensiometer capable equipped with sample stage, temperature control and force balance capable of 10 μg force resolution (Krűss K100 force tensiometer, or equivalent)

Glass Cover Slides—Cover glasses, square 22×22 mm (VWR Catalog Number: 48366-227, or equivalent)

Force Balance Software—Software capable of converting mass into total surface tension (Krűss Laboratory Desktop Software version 3.2.2.3044, or equivalent)

Goniometer—An instrument consisting of a high-resolution camera and zoom microscope, PCI frame grabber card, computer-controlled syringe pump and volume dispensing, and adjustable specimen stage to hold the sample (First Ten Angstrom, Model 200, or equivalent).

Imaging Software—Software capable of measuring and extracting contact angle data from an image or video file (FTA software version 2.1 Build 378, or equivalent)

Hypodermic Syringe—A gas tight syringe, such as a 3-mL hypodermic, equipped with a No. 27 gauge blunt tipped stainless-steel needle, capable of providing 100 to 200 drops from 3 mL.

### Wilhelmy Plate Method

### Test Preparation:

Surface contamination is avoided by wearing clean nitrile gloves and working on a clean surface in room clean of atmospheric contaminates and dust. 22×22×0.15 mm (L) glass cover slides are mounted in a rigid sample holder clip (Krűss model CLMP 10) so that it can be inserted perpendicular into the ink sample fluid. The cover slip is passed through a flame 6 times to thoroughly clean surface prior to the experiment. 20 mL of sample is introduced into a clean vial of sufficient diameter to prevent edge effects.

### Procedure

The sample is raised at 6 mm/min until the surface is detected (0.01 g sensitivity on microbalance). The cover slip is then introduced 2 mm into the ink sample. Mass of the glass cover slide is determined by the microbalance every 2 seconds for a total of 120 seconds. Wilhelmy equation of state is used to convert mass into total surface energy by the Krűss software. The surface tension reduced in magnitude with time until the standard deviation for five sequential measures is minimized. At this point the surface tension is considered at equilibrium.

### Total Surface Tension Calculation:

A plate material with a high surface energy (ie. glass) is chosen because it can be optimally wetted and therefore generally forms a contact angle (θ) of 0° (cos θ=1) with liquids. The required variable σ can be calculated directly from the measured force.

$$σ = F / ( L cos θ )$$

where
F=force in mN/m, L is the wetted length
σ=total surface tension in dyn/cm
θ=contact angle in degrees

### Contact Angle Method

### Positioning of Substrates

Surface contamination is avoided by wearing clean nitrile gloves and working on a clean surface in room clean of atmospheric contaminates and dust. A 2.0-3.0 cm strip of lubricating material is obtained without contaminating the surface of the substrate except by clean atmospheric gases. A strip of double-sided sticky tape, 2 cm wide by 6 cm long, is mounted along the edge of a clean glass microscope slide longitudinally avoiding wrinkling and trapped air bubbles as much as possible. The sample is mounted on the tape along the edge longitudinally avoiding wrinkling and trapped air bubbles as much as possible. The mounted sample is placed on the specimen stage under the syringe. The sample should not be touched with the fingers or contaminated in any other way during positioning on the specimen stage.

### Procedure

Thermal regulation (±1 C) is utilized to ensure temperature fluctuations do not significantly influence the measurements. Humidity control (±5% relative humidity) so that the general condition of the surface does not change significantly with change in humidity. In all cases, the humidity and temperature are recorded prior to data collection.

Set up the goniometer and level the stage according to the manufacturer's instructions.

Measure contact angles of each discrete droplet of ink on the lubricating material sample as described in ASTM D7334 or the manufacturer's literature for the instrument being used.

Set the tip of the hypodermic needle at the distance from the surface recommended by the manufacturer of the instrument (3 mm (⅛ in.) and deposit a drop of test liquid 3-5 μL in size on the sample.

### Contact Angle

Focus the camera or video device so that the image of the drop can be captured.

Make two angle measurements (one on each drop edge) of each of test fluid on the sample using commercial software designed to extract contact angles from movies or images (for example, First Ten Angstrom software version 2.1, build 378, or equivalent). If the contact angles on two edges are different by more than 4°, the values should be eliminated and the test repeated. This measurement is repeated 5 more times on new droplets. The contact angle for the sample shall be the average of the ten angles measured for each side.

### High Speed Video Imaging.

The image acquisition speed should capture at least 10-20 images from the time the drop hits the surface to the time it cannot be resolved from the surface of the sample. This work utilized a capture rate of 100 images/s. The software described above extracted the contact angles from the video feed. The volume is also calculated using the same software under the sessile volume. The contact angles are plotted with the sessile volume plots. Ideally, enough time is allowed for the drop to wet out to equilibrium. However, in highly absorptive systems the drop absorbs into the material before equilibrium is achieved. In these cases, in which the drop rapidly (<0.2 s) absorbs into the substrate, video was progressed until 2% of the volume of the drop absorbed into the substrate. The contact angle is recorded at that time point. This might mean the first resolved image in extremely fast absorbing systems if the second image shows more than 2% volume loss.

### Work of Adhesion:

The work of adhesion (W) using the Dupré equation of state:

$${W}_{SL} = {Y}_{L} ( cos θ + 1 )$$

Where:
W_{SL}=the work of adhesion between a solid and liquid in dyn/cm
Y_{L}=the total surface tension of the liquid in dyn/cm
θ=the contact angle in degrees

Reference: A. Dupré, Theorie Mechanique de la Chaleur; Gauthier-Villars: Paris, 1869; pp 36W.

### Wear Method:

### Equipment/Calibration

Gillette Wear Tester, Assembly #45235-A (Brookfield Machine)

Insert Wear Tester is an instrument that holds a razor cartridge against a revolving wheel fitted with a wool felt surface. The wheel rotates partially submerged in a bath of deionized water, to maintain the wet surface. The wheel is controllable to set a constant angular velocity—25 rpms. The wear tester is used to assess relative performance between lubricating members and not for absolute results. Thus, different set ups may be used to obtain the relative performance data being sought.

### Procedure:

Insert lubricating material into a shaving cartridge. Prepare and weigh 5 cartridges with lubricating material to be tested for each of the following sets of revolutions: 5, 10, 15, 25 & 50 rev.

### Pre-Soak Cycle

1) If the wear tester is just starting up or wool felt has not been used for a while, it is advisable to run a long soak cycle prior to performing any tests. It is advised to soak the wool felt in water for 16 hours before testing.
2) Fasten wool felt to test wheel. Ensure wool felt is tight, centered, and properly aligned before starting.
3) Fill water bath with ˜6.5 L deionized water at room temperature.
4) Fill the soak pan sufficiently (to approx. 1.5″ from top of pan) to ensure that the bottom of the wheel dips ½ to 1 inch into the water. Fresh water should be used at the start of each day testing is done Wear Cycling
5) a) Place test sample into appropriate cartridge fixture.
6) Secure sample into position and examine to ensure that it is flat and stable.
7) Place cartridge fixture into wheel bay:
8) Start wear cycling, by selecting 5, 10, 15, 25 or 50 revolutions to be run on the samples according to the test plan.
9) Press START button.
10) After each run, the samples should be placed in a tray, lubricating material facing up, and not in contact with other samples
11) Repeat wear cycling until all samples are tested.
12) Empty and clean water bath when testing session is finished.
13) Dry samples overnight (16-24 hours) in the oven at 55° C. to remove excess water.

### Sample Measurement

a) Remove samples from oven and allow to equilibrate at room temperature for 1 hr.
b) Weigh each sample to determine the weight loss.
c) Record final weight of each sample.

It should be understood that every maximum numerical limitation given throughout this specification includes every lower numerical limitation, as if such lower numerical limitations were expressly written herein. Every minimum numerical limitation given throughout this specification includes every higher numerical limitation, as if such higher numerical limitations were expressly written herein. Every numerical range given throughout this specification includes every narrower numerical range that falls within such broader numerical range, as if such narrower numerical ranges were all expressly written herein.

All parts, ratios, and percentages herein, in the Specification, Examples, and Claims, are by weight and all numerical limits are used with the normal degree of accuracy afforded by the art, unless otherwise specified.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A razor cartridge comprising;
a. a guard at a front portion of said cartridge, a cap at a back portion of said cartridge, at least one blade positioned between said guard and said cap, a top surface, and a lubricating member positioned at said top surface, said lubricating member having a visible surface, said visible surface having a visible surface area;
b. a printed structure on said visible surface of said lubricating member, said printed structure comprising a UV curable ink covering a portion of said visible surface area creating a printed portion and an open portion, said UV curable ink having a contact angle from 65 to 80 degrees with the lubricating member and a work of adhesion from 45 to 60 mJ/m² with the lubricating member.

2. The razor cartridge of claim 1, wherein the lubricating member within the open portion is directly exposed to a user's skin during shaving.

3. The razor cartridge of claim 1, wherein the printed portion is directly exposed to a user's skin during shaving.

4. The razor cartridge of claim 1, wherein said lubricating member is positioned on said cap.

5. The razor cartridge of claim 1, wherein said lubricating member is positioned on said guard.

6. The razor cartridge of claim 1, wherein said lubricating member at least partially surrounds said blade.

7. The razor cartridge of claim 1, wherein said lubricating member completely surrounds said blade.

8. The razor cartridge of claim 1, wherein the printed structure comprises a plurality of printed droplets.

9. The razor cartridge of claim 1, wherein the printed structure depicts alphanumeric text

10. The razor cartridge of claim 1, wherein the printed structure depicts non-alphanumeric graphics

11. The razor cartridge of claim 1, wherein said printed portion covers from 3% to 70% of the visible surface area.

12. The razor cartridge of claim 1, wherein said printed portion covers from 5% to 40% of the visible surface area.

13. The razor cartridge of claim 1, wherein said printed portion covers from 10% to 30% of the visible surface area.
